(19) United States
(12) Patent Application Publication
(10) Pub. No.: US 2007/0001344 A1
(43) Pub. Date: Jan. 4, 2007

(54) Method and device for the production of injection moulded parts

(76) Inventors: Robert Weinmann, Weesen (CH); Andreas Lind, Galgenen (CH); Jurg Eberle, Reichenburg (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/546,156

(22) PCT Filed: May 19, 2003
(86) PCT No.: PCT/CH03/00317

§ 371 Date: Jul. 24, 2006

(30) Foreign Application Priority Data
Feb. 20, 2003 (CH) 264/03

(51) Int. Cl. B29C 45/00

(52) U.S. Cl. 264/328.17; 264/328.18; 425/209

(57) ABSTRACT

The invention relates to a method and device for the production of injection moulded parts, especially preforms, in an injection molding method. The raw material and the additives are fed to a plasticizing worm (4) which injects pressurized plastic melt into the cavities of an injection mould (7,8) and the injection molded parts are removed from the moulds after cooling has occurred. According to the invention, the additives, especially AA blockers or coloring, are added directly to the worm cylinder in liquid form in a dosed manner after the raw material has been inputted. The invention relates more specifically to the injection molding of preforms for the production of PET bottles. One advantage of the invention is that it enables the acetaldehyde content to be reduced by 50%, the dosing time can also be reduced significantly and said dosing can be stabilized in a significant manner.

### TECHNICAL AREA

The invention relates to a method for the production of injection moulded parts, in particular of preforms in the injection moulding method, with raw material and additives being fed to a plasticizing worm in a dosed manner, the plastic melt the being injected into the cavities of an injection mould under pressure, and the injection moulded parts being removed from the forms after cooling has occurred.

The invention furthermore relates to a device for the production of injection moulded parts, in particular preforms in the injection moulding method, with plastic raw material and additives being fed to a plasticizing worm, the plastic quantity being injected into the cavities of an injection mould in shots, and the injection moulded parts being removed from the forms after cooling has occurred.

The new invention is explained in the following using the production of preforms for the fabrication of PET-bottles. The starter materials in the synthesis of PET are ethylene glycol and para-terephtalic acid, both of which can be produced 100% from crude oil or natural gas. The first step is the estrification of ethylene glycol and para-terephtalic acid, which occurs by splitting off water. This results first in ethylene terephtalic acid, and in the subsequent poly-condensation stage, with additional splitting off of water, in polyethylene terephtalate (PET). Approximately 1.9 kg of crude oil yield approximately 1 kg of PET granulate. Because of estrification reaction, PET is often also referred to as polyester.

### STATE OF THE ART

The production of bottles made from PET is comprised of two steps. In the first step, the PET-granulate is injection-moulded into a preform in the injection moulding process. For this purpose, the granulate is dried in a large silo for approximately 4 to 6 hours at 100° C. so that it reaches a residual moisture content of <30 ppm (parts per million). Then the dried granulate is transported over a vacuum system into a booster over the PET machine and heated to 170° C.

The granulate flows through a hose into the plasticizing unit, where the granulate grains are melted, compressed, and homogenized. The injection piston transports the melt into the PET tool with approximately 900 bar or more, where the preforms are formed. By means of a robot system, the preforms are removed from the tool while still hot and transferred to a cooling station, where the preforms are cooled for three to four cycles. In the second step, the preforms are fed to the stretch blow moulding machine. In a heating path, the preforms are first heated briefly to a forming temperature of approximately 90 to 120° C. by means of shortwave infrared radiation. The preform is inserted into the blow cavity and formed in a combined stretching rod- and compressed air forming. The plastic is cooled again at the cold forming wall and removed from the mould. The bottle is now ready to be filled with any liquid commercial consumer goods.

An important criterion for the processing process is the quality of the preforms and/or the PET bottles produced therefrom. The quality of the bottle is depends largely on the quality of the preforms. Through the stretching and blowing of the preform, the geometry and the wall strength determine the wall strength distribution and thus also the geometry of the bottle. The preforms assume a substantial role in the production of the PET bottles. Therefore, the preforms are subject to the following quality control tests:
Weight
Wall strength
Geometry
Optical test
Taste test

A first central parameter in view of the new invention is the taste test. This relates primarily to be acetaldehyde. Foreign components may not influence the taste and odor of the filling medium. This is why the PET bottles are subjected to various tests. Substances with a fruity taste can be determined. In particular in the production of preforms for the production of mineral water beverage bottles, the challenge to the preform manufacturer is to keep the acetaldehyde value as low as possible so as not to negatively affect the taste of the mineral water. In the processing of PET, acetaldehyde may be generated as a breakdown product of the polymer chains. A degradation of the polyester chains during the melt on process leads to the formation of acetaldehyde. The essential factors of influence which can lead to the formation of acetaldehyde during injection moulding are the temperature and the standing time of the melt at high temperature.

Acetaldehyde is a simple organic compound (CH₃CHO). It is a colorless, volatile liquid (boiling point 20.8° C.) with a clearly noticeable fruity odor. Fruit that is almost ripe has a natural acetaldehyde component. This applies, for example, to apples and citrus fruit. In the food industry, acetaldehyde is added as a flavor enhancing additive to many foods. For example, ice cream and chewing gum contain acetaldehyde. Acetaldehyde is formed in the fermentation of sugar into alcohol and can also be found in human blood. Therefore, acetaldehyde can be considered physiologically safe. As an additive to foods, acetaldehyde is officially approved in the “Handbook of Food Additives”.

Because the taste and the odor, in particular with mineral water, are not supposed to be influenced by foreign components, the acetaldehyde content in the bottle should be as low as possible. Water reacts particularly sensitive to even the slightest changes in odor and taste. A clean, original and natural taste of the mineral water must be preserved even in the PET bottle. For this reason, detailed studies have been performed on the subject of acetaldehyde in water. These studies have revealed that the taste threshold for sensory detection of acetaldehyde in mineral water is substantially lower than the odor-related threshold. The odor-related threshold depends on the subjective perceptions of the test person as well as on the own taste (mineral component, etc.) of the mineral water. While the threshold is between 20 and 40 ppm for an untrained person, a specially trained person who is sensitive to taste can already register 10 ppm acetaldehyde in water. Therefore, depending on the application of the PET bottle (water, soft drink, cooking oil, etc.), different threshold values were defined for the acetaldehyde content in the preform (ppm) and in the bottle (μg/l). These limit values guarantee that the consumer cannot detect any change in the taste of the beverage caused by acetaldehyde. The limit values in the preform are defined as follows:

| | Mean value | Maximum value |
|---|---|---|
| Mineral Water with CO₂: | <3.0 ppm | <4.0 ppm |
| Carbonated soft drinks: | <4.0 ppm | <8.0 ppm |

To date, there is no direct correlation between the AA-content in the preform and the AA-content in the filling. There are a number of alternating effects between the filling, the packaging and the environment, which affect the quality of the filling. The acetaldehyde, which is “stored” in the walls of the bottle after it has formed, migrates into the filling after a certain time. These migration processes, i.e., the speed of the transfer of acetaldehyde from the walls of the bottle into the packaging, depend on the environmental conditions. Essential parameters include the ambient temperature. The migration increases with rising temperature.

Empirical values furthermore showed that a small portion of acetaldehyde (approx. 1 ppm) is already generated in the production of PET granulate. The largest acetaldehyde portion, however, is formed in the injection moulding process during the production into the preform. As explanation, and for solving this problem, one has to take a detailed look at the complete PET-line-system. Studies have shown that the following components of a PET-line-system are of importance with respect to the acetaldehyde:
Dryer
Plasticizing unit
   Temperature
   Worm speed
   Back pressure
Mixing elements for homogenization
Tool (hot runner)

With a worm designed specifically for the processing of PET, the plasticization of the granulate is performed by thermal conduction (contact between the granulate and the cylinder wall) and by shearing (friction), with the melt being subjected to a thermal and mechanical load. Said loads may lead to a degradation of the PET molecule. Acetaldehyde is formed as a fission product of the degradation. To generate as little as possible acetaldehyde in the plasticization, a small amount of acetaldehyde blocker is mixed into the dry plastic granulate prior to entering into the plasticizing worm. However, experience has shown that the acetaldehyde blocker has a negative influence on the stability of the dosing process for the plastic melt such that the addition of acetaldehyde blockers requires a longer dosing time of up to 3 seconds. This means that a second central parameter is the stability of the dosing process and the cycle time.

The new invention was based on the problem of improving the method and the device, in particular the known disadvantages in the addition of additives, in particular of acetaldehyde blockers or liquid coloring, and to optimize the advantages of these additives, with increased stability and a dosing time that may not being longer.

### REPRESENTATION OF THE INVENTION

The method in accordance with the invention is characterized in that the additives are added in a dosed manner directly into the worm cylinder separately from the raw materials that are added.

The device in accordance with the invention is characterized in that it has at least one liquid dosing device for additives through which additives can be adapted to the granulate transport of one shot and added directly into the worm cylinder in the direction of the worm transport after the location where the plastic raw materials are added.

The inventors have realized that the state of the art did not attribute sufficient attention to the entire problem area of the transition from solid matter to liquid. The plastic raw material is generally added to the plasticizing worm in the form of granulate, i.e., in dry form, through a feed hopper. The additives are added to the feed hopper in a dosed manner in liquid form with per hundred- or per thousand parts, and mixed into the granulate by means of an agitator. The liquid additives adhere to the surface of the single granulates and deteriorate the degree of transport efficiency in the worm cylinder. The liquid additives generate a smear effect on the plasticizing wall, which is disadvantageous for transport. Therefore, the transport effect is better and the dosing time is shorter without additives.

With the new solution, the liquid additive is added directly into the worm cylinder only after the raw material has been added. This means ensuring the best possible intake conditions with completely dry granulate. In a manner for which there is not yet an explanation, the new solution not only effects an improvement in the acetaldehyde blocker effect, but surprisingly also allows an enormous shortening of the dosing time by 1 to 3 seconds. The new solution has a favorable impact on the entire dosing process, primarily on the preparation of the melt.

The new solution allows a number of especially advantageous embodiments.

The additives are introduced in liquid form in an area of the rising pressure curve of the intake zone of the plasticizing worm at a correspondingly higher pressure, with two or more additives, if applicable, being added separately into the worm cylinder. The additives can be added over two or more areas of the intake zone. Depending on the individual case, this allows an optimization of the adding disposition, also depending on the entire worm geometry.

The new solution is particularly suitable for the production of preforms for the fabrication of PET bottles, with the acetaldehyde being added in a dosed manner in the area of the intake zone of the plasticizing worms. Furthermore, first taste tests yielded positive results in the production of injection moulded parts, in particular preforms with the addition of liquid coloring in the area of the intake zone of the plasticizing worm. In both cases, the dosing device for the liquid was developed as hydraulic pump and/or as constant volume pump.

According to the preferred embodiment, the dosing device for the liquid has an assigned control/regulation through which additives can be added continuously to the plasticizing worm in shots through a pressure function and/or a transport function. In the case of the pressure function, the melt pressure can be detected through a sensor in the area of the location where the additives are added, and the timeline of the dosing of the additives can be controlled accordingly. In the case of the transport function, it is first and foremost the path function of the plasticizing worm that allows a controlled dosing. The location where additives are added is arranged in an offset by at least the measure of one flight in the direction of transport relative to the location where the plastic raw material is added, with the location where the additives are added being designed like a narrow nozzle in the casing of the injection cylinder, preferably in a radial arrangement. In this way, a precise addition is ensured without the granulate being able to enter into the location where the additives are added.

At least one active location where additives are added and at least one other passive, closed location where additives are added can be arranged; in the case of two or more locations for adding additives, said locations for adding additives are arranged offset in axial direction or in the direction of the circumference of the plasticizing cylinder.

### BRIEF DESCRIPTION OF THE INVENTION

The invention will now be explained by means of some embodiments and additional details:

Shown are:

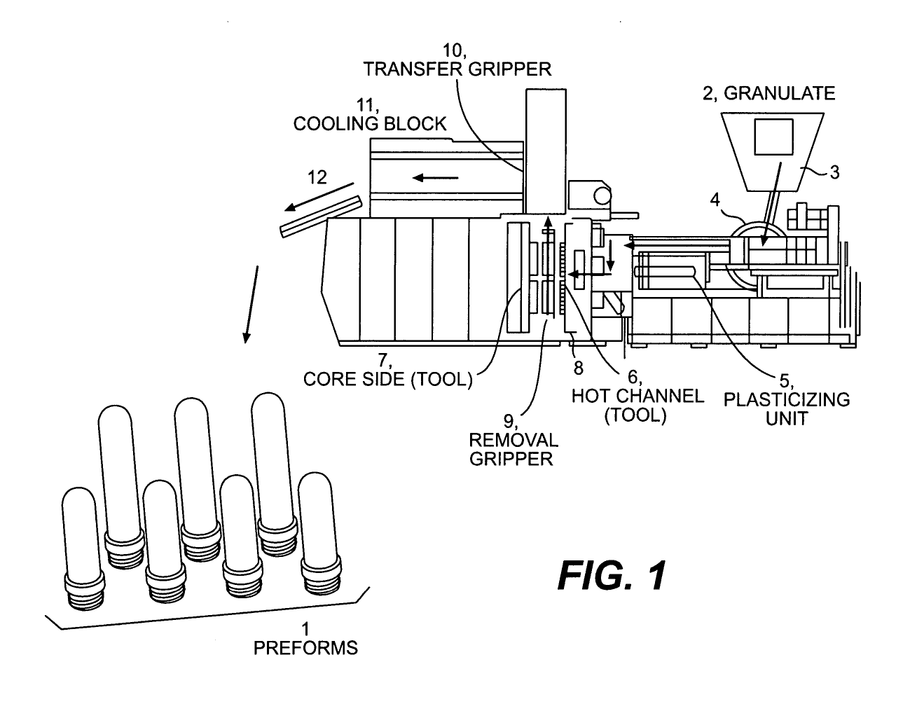

in FIG. 1: an overview of the injection moulding machine for the production of preforms;

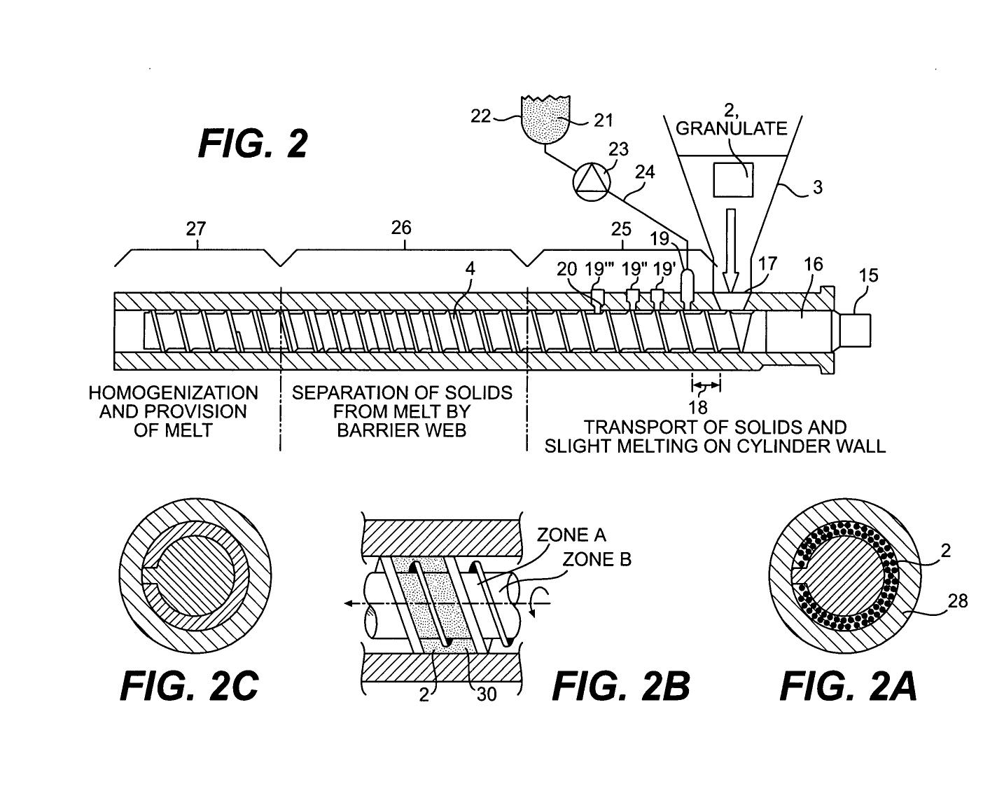

in FIG. 2: a typical plasticizing worm with the addition of the additives in accordance with the invention;

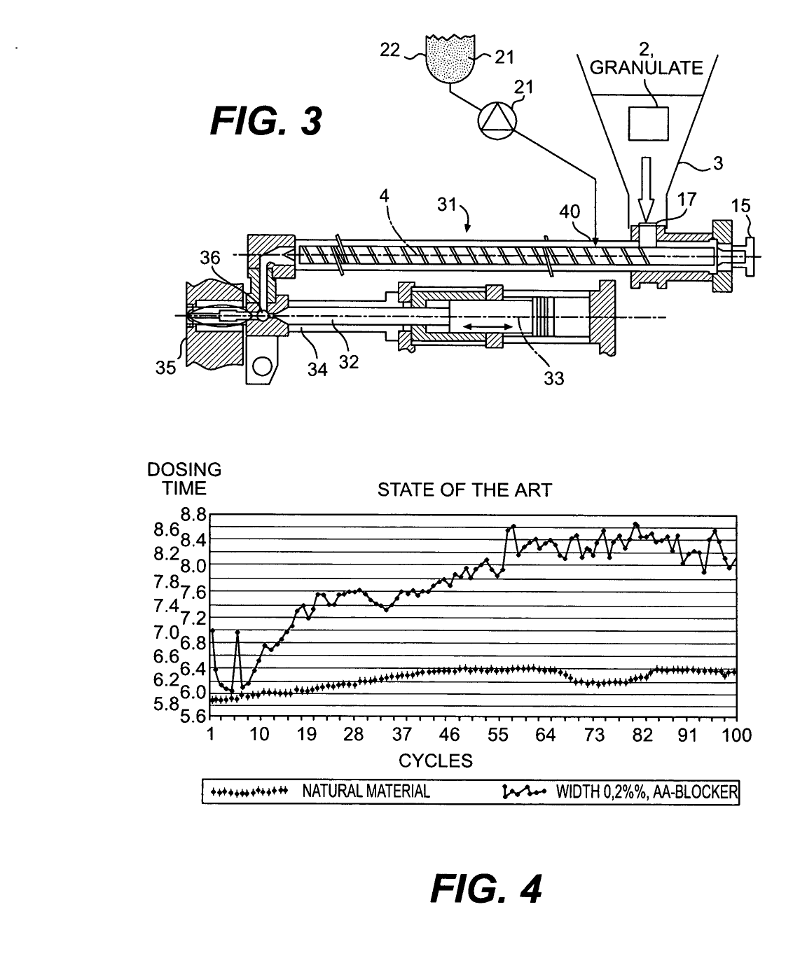

in FIG. 3: the most important components of an injection aggregate in the two-step method;

in FIG. 4: a comparison of the dosing time with biological materials and with the addition of 0.2% AA blocker;

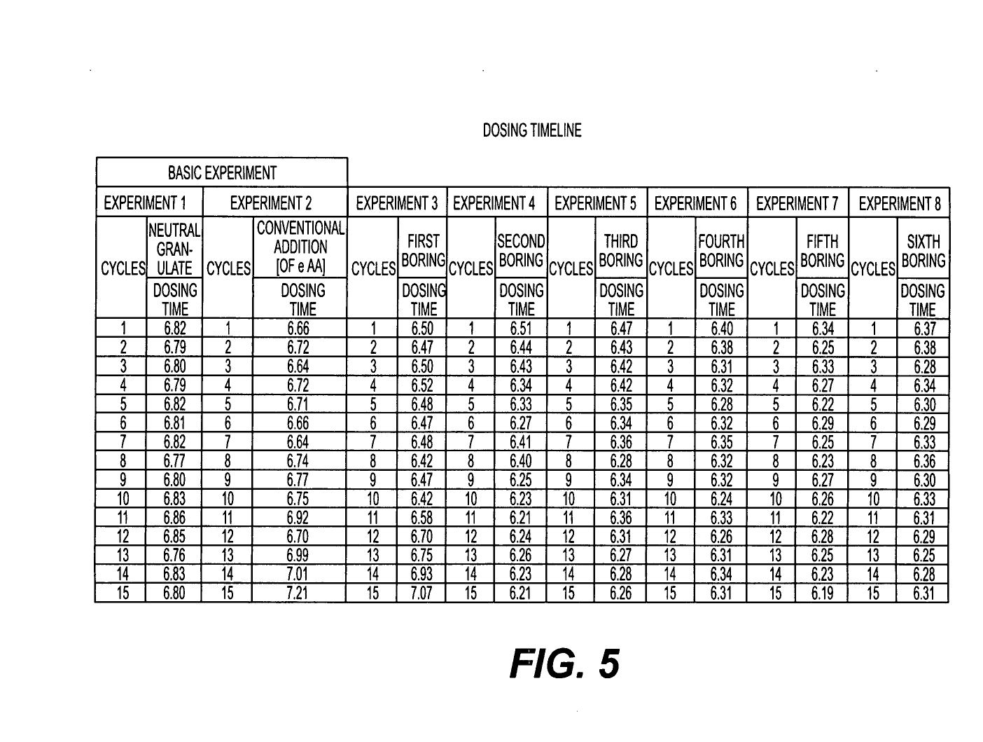

in FIG. 5: the dosing timeline of a number of test results of 15 cycles as well as 8 different experiments;

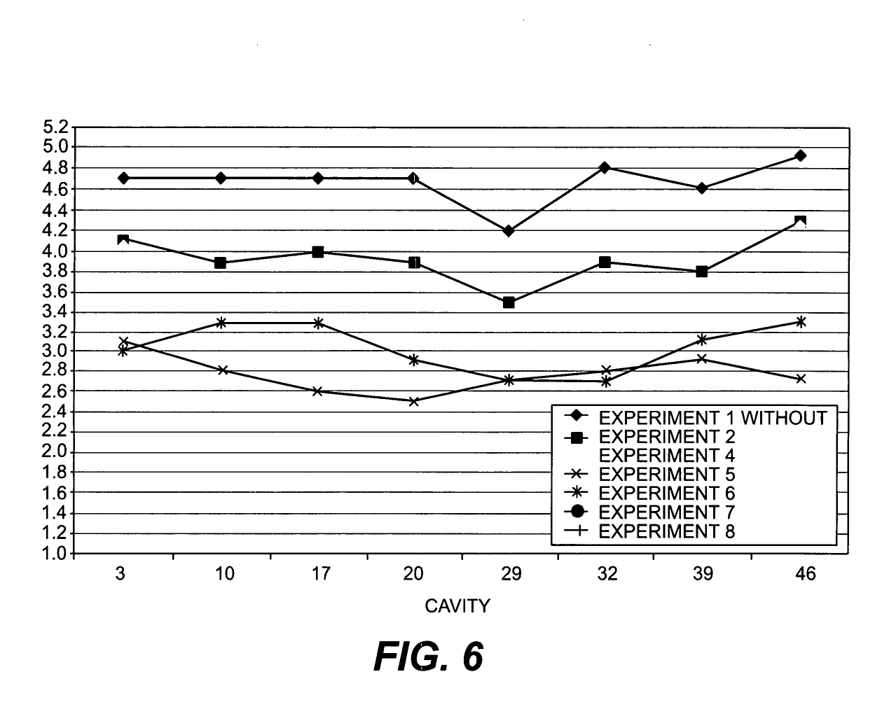

in FIG. 6: the AA-content of several experiments in ppm in various cavities of the injection mould;

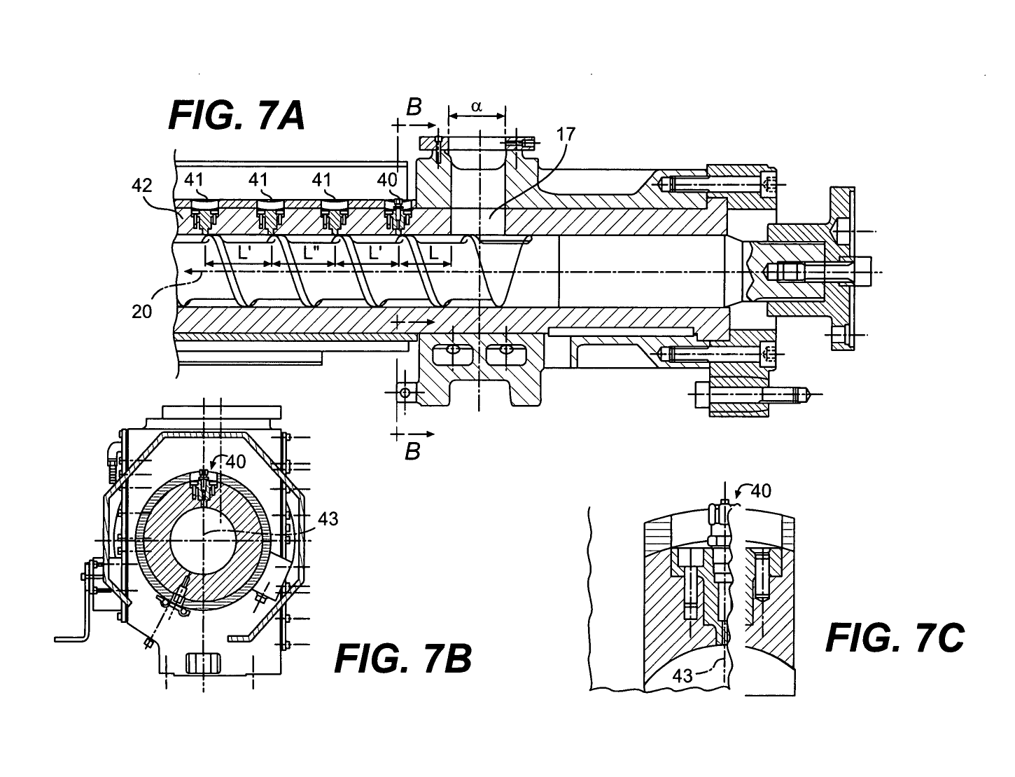

in FIG. 7a: a section in the first area of the plasticizing worm;

in FIG. 7b: a section B-B of FIG. 6a;

in FIG. 7c: the enlargement of a section of the location for adding the additives;

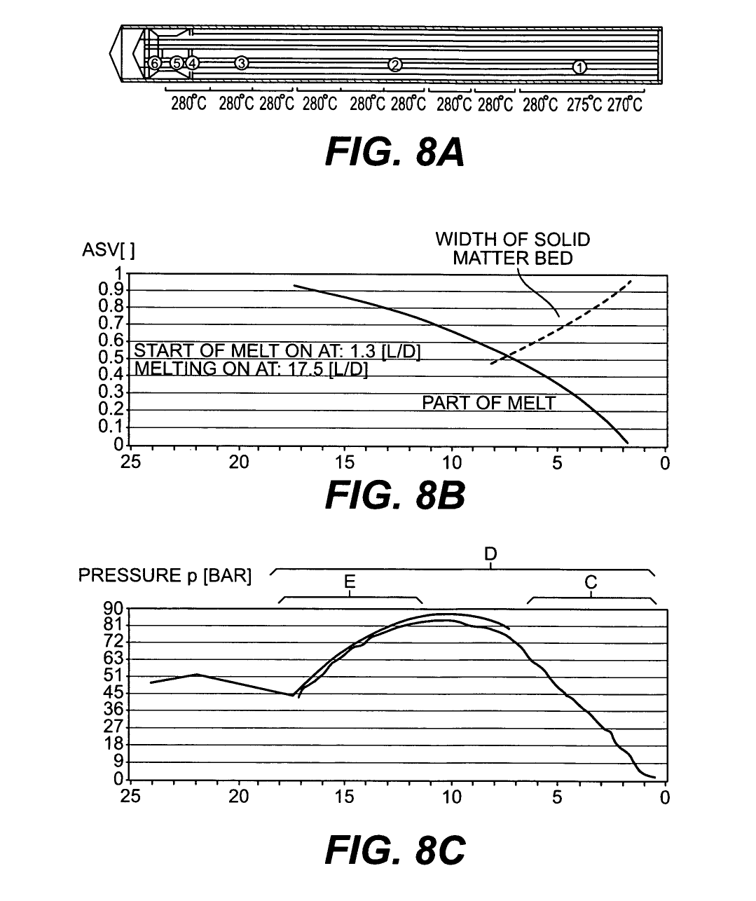

in FIG. 8a a plasticizing worm with the different method zones, in schematic view;

in FIG. 8b: matching FIG. 5a, the melt portion over the various method zones of the plasticizing worm;

in FIG. 8c: the course of pressure over the entire length of the plasticizing worm.

### WAYS AND EXECUTION OF THE INVENTION

FIG. 1 shows the core components of an injection moulding machine for the production of preforms, with 1 referring to the finished preforms. The raw material is transferred in the form of granulate 2 through a feed hopper 3 directly into the plasticizing worm 4 and from said plasticizing worm 4 into a plasticizing unit 5 in the form of processed melt. The liquid melt is injected in shots through a hot channel 6 into the cavities of the mould halves 7 and 8. After a sufficient drop of the fresh injection moulds, the mould halves 7 and 8 are opened and a removal robot 9 drives between the open mould halves and takes up the still hot preforms, transfers them to a transfer gripper 10 after an intensive cooling has occurred, and said transfer gripper transfers the preforms in a cooling block 11 for the complete cooling. The arrow 12 refers to the drop of the preforms 1 that have finished cooling. A complete injection moulding cycle lasts 10 to 15 seconds and the secondary cooling lasts 30 to 60 seconds. In the case of preforms, the cycle times are largely determined by the wall strength of the individual preforms. FIG. 1 only indicates various colored preforms. In practice, the injection moulding cycle with secondary compression, cooling and removal generally determines the cycle time. However, in individual cases, the preparation of the melt toward the neck of the bottle took longer, with the preparation of the melt requiring more time than the injection moulding cycle. This is where the new solution offers special advantages.

FIG. 2 shows a plasticizing worm 4 on a larger scale. Said plasticizing worm has, on the right in FIG. 2, a drive stub 15 with a cylindrical shaft part 16. The intake area 17 is approximately the same length as a flight 18. The intake location for the additives 19 is arranged by about the length L of a flight 18 in transport direction of the melt, arrow 20. The additive 21 is added from the tank 22 through a volume- and/or hose pump 23 as well as a feed line 24 through the location where the additives 19 are added in the worm cavity. The plasticizing worm 4 is developed with various worm profiles as well as pitches over the entire length. The first zone primarily has a transport effect and is referred to as the intake zone 25. The intake zone 25 is followed by a barrier zone 26 with little worm pitch. Last is a metering zone 27. In the intake zone 25, the plasticizing worm 4 transports dry granulate 2. However, a slight melt starts immediately at the heated cylinder wall 28 (FIG. 2a). The barrier zone 26 has the special function to separate the solid matter 2 and the melt 30 by barrier webs (FIG. 2b). The main function of the metering zone is to homogenize the melt 30 and to provide said melt for the respective next shot (FIG. 2c). In addition to the location 19 for adding the additives, FIG. 2 shows additional locking threads 19′, 19″, 19′″, etc. This indicates additional possible locations for the adding the additives. The plasticizing worm cylinder is made of special steel so that the injection moulding technician cannot simply drill holes into the plasticizing worm cylinder. Therefore, it is proposed to provide several borings already during the production of the machine, which can be either used or closed, depending on the particular application.

FIG. 3 shows a complete injection unit 31, with the upper part of the image corresponding to FIG. 2. The injection cylinder 32 in the lower part of the image moves through a hydraulics cylinder 33 with appropriate control means in the cycle of the injection cycle. It is assumed that this part is known. Upstream of the injection piston 32 is a melt depot 34, which is injected in shots into the cavities of the form through a hot runner nozzle 35. A valve 36 is opened and closed in the rhythm of the injection cycle so that either a one-shot quantity is transferred from the plasticizing worm 4 to the injection piston 32, or injected by the injection piston 32 into the cavities.

FIG. 4 then shows a very interesting comparison. Biological material (lower curve) was processed over 100 cycles and under the same conditions, plastic material was processed with the addition of 0.2% AA blocker. As in the state of the art, the AA blocker was added in a dosed manner into the feed hopper. The difference is very pronounced because not only did the dosing time become very irregular after the addition of AA blockers, but it was also increased by 6 to 6.4 seconds to 7 to 8 and more than eight seconds. As a result, the addition of AA blocker has a noticeable negative effect on the dosing regularity as well as on the dosing time in the state of the art. This corresponds to the experiences of the experts.

FIG. 5 shows the dosing timeline over 15 cycles compared to the state of the art (Experiments 1 and 2) as well as the new solution (Experiments 3 to 8). The experiments were performed to determine optimization, in particular with respect to the issue as to where the best results are obtained with respect to the length of the plasticizing worm. In all experiments, the same basic conditions were observed, particularly with respect to product and throughput performance. In Experiment 2, the AA blocker was placed into the feed hopper; in Experiment 3, the AA blocker was added in an approximate distance of 90 mm relative to the location where the raw material was added, and in the following experiments approximately 100 mm farther away from the location where the raw materials were added, respectively. What is interesting is the earlier observation, i.e., that with the addition of AA blockers, the dosing time undergoes strong fluctuations over the 15 cycles without any obvious reasons. With the exception of the cycles 14 and 15 in Experiment 3, all results showed lower values and a surprising stability with the use of the AA blocker in accordance with the invention. This means that the distance of the location for adding the additives is just about at the limit so as to be able to use a noticeable advantage of the new invention.

FIG. 6 shows the aspect of AA content compared to the various experiments with respect to different cavities. The upper curve (Experiment 1) shows values of 4.2 to 4.8 ppm. This is logical as such because no AA blocker was used here. In the second curve from the top (Experiment 2), AA blocker was mixed into the feed hopper 3 in a conventional manner. The AA content is between 3.5 and 4.4 ppm, i.e., it is clearly lower compared to the top curve. The two lower curves very clearly show the advantage of the new solution because the AA content is now between 2.5 and 3.3 ppm.

The FIGS. 7a to 7c show the locations for adding the additives, using a section of a typical worm design in an area of the locations for adding the additives. The intake area for the raw material 17 is marked with a diameter symbol d, with L:d being approximately 1:1. In the shown example, the location 19 for adding additives is in a distance L, with a connection nipple 40 for the additives being screwed into the respective boring. In a distance of respectively L′, and/or L″, and/or L″′, the boring is closed by the cylinder wall 43 with a plug 41 respectively. The embodiment of the plasticizing worm 4 is also assumed to be known. FIG. 7b is a section B-B of the FIG. 6a, and the FIG. 7c is an enlargement of the connection nipple 40. What is important is that the connection nipple has a fine nozzle-like outlet 43. This facilitates an exact dosing of the additives and prevents clogging by the melt material.

FIG. 8a schematically shows a plasticizing worm with the associated diagrams for the melt part (FIG. 8b) as well as the march of pressure (FIG. 8c). Preferably, the liquid additives are added in the area of the first increase of pressure in the area of the intake zone, which is labeled with (1) for the worm. Depending on the location where the liquid additives are added, the pressure in the hose pump has to be adjusted and/or increased accordingly. FIG. 8b shows that the portion of the melt increases immediately from the intake area into the direction of transport. An especially interesting aspect of the new invention is that the liquid additives are added at a location in the plasticizing cylinder where at least a portion of melt has already formed. Depending on the goal to be attained with the addition of AA blockers, the result is two areas C and D. Area C makes sense if the formation of acetaldehyde is supposed to be lowered to the lowest possible value during the plasticization. However, if the goal is to lower the formation of acetaldehyde in the subsequent steps of the procedure, the AA blocker can be added over the entire area D. It is also possible, however, to add the additives in Zone C as well as in Zone E, depending on the objective. If two or more additives are added, it is recommended to add them successively over the length of the plasticizing worm.

1. Method for the production of injection moulded parts, in particular of preforms in the injection moulding method, comprising:
feeding raw material and liquid additives in a dosed manner to a plasticizing cylinder having a plasticizing worm and the additives being introduced in liquid form separately from the raw material feed directly into the plasticizing cylinder in an area (“C”) of an intake zone, and the mixture of raw material and liquid additives being injected in shots into cavities of an injection mould,
wherein,
the quantity of the additives is predetermined and added based on the shot quantity for one injection moulding cycle,
with the additives being fed in a distance to the location where the raw material is added which corresponds to at least the measure of one flight to ensure optimum intake conditions with dry granulate.

2. Method in accordance with claim 1,
wherein,
the quantity of the additives is adapted to the granulate transport of one shot and added continuously.

3. Method in accordance with claim 1 or 2,
wherein,
the additives are added continuously in shots for a pressurized function and/or a transport function of the plasticizing worm, with the dosing being controlled by the path function of the plasticizing worm in the case of the transport function.

4. Method in accordance with claim 1,
wherein,
in case of two or more additives, said additives are added separately to the worm cylinder, and the additives are preferably added over two or more areas of the intake zone.

5. Method in accordance with claim 1,
wherein,
for the production of preforms, in particular for the fabrication of PET bottles, acetaldehyde blockers are added in a dosed manner in the area of the intake zone of the plasticizing worms.

6. Method in accordance with claim 1,
wherein,
for the production of injection moulded parts, liquid coloration is added in the area of the intake zone of the plasticizing worm.

7. Apparatus for the production of injection moulded parts, in particular of preforms in the injection moulding method, comprising:
a cylinder with a plasticizing worm, where plastic raw material and liquid additives are added in shots to the plasticizing worm, the injection moulded part being removable after the cooling of the mould forms has occurred, and with the apparatus having at least one liquid dosing device for additives to add additives directly into the cylinder in a direction of the worm transport after the location where the plastic raw material is added,
wherein,
the liquid dosing device has an assigned control/regulation to continuously add the predetermined quantity of additives based on the shot quantity for one injection moulding cycle and the location for adding additives is arranged in an offset by at least the measure of one flight in the direction of transport relative to the location where the plastic raw material is added.

8. Apparatus in accordance with claim 7,
wherein,
the liquid dosing device is developed as a constant volume pump, in particular as a volume-and/or hose pump, and the quantity of the additives can be added continuously.

9. Apparatus in accordance with one of the claims 7 or 8,
wherein,
the location for adding the additives is developed narrow like a nozzle in the casing of the injection cylinder and is arranged preferably as a radial orifice.

10. Apparatus in accordance with claim 7,
wherein,
at least one active location for adding additives and at least one additional passive, closed location for adding additives are arranged.

11. Apparatus in accordance with claim 10,
wherein,
with two or more locations for addition additives, said in locations for adding additives are arranged in an offset in axial or radial direction of the plasticizing cylinder.
